(19) United States
(12) Patent Application Publication
(10) Pub. No.: US 2005/0038992 A1
(43) Pub. Date: Feb. 17, 2005

(54) Method for sending multiple ephemeral terminations in a single service change message

(76) Inventor: Mariana Benitez Pelaez, Naperville, IL (US)

Correspondence Address: Docket Administrator (Room 3J-219);Lucent Technologies Inc., 101 Crawfords Corner Road, Holmdel, NJ, 07733-3030, US

(21) Appl. No.: 10/630,191

(22) Filed: Jul. 30, 2003

Related U.S. Application Data
(60) Provisional application No. 60/472,811, filed on May 22, 2003.

(51) Int. Cl. H04L 9/00

(52) U.S. Cl. 713/160

(57) ABSTRACT

The present invention provides a method for taking multiple ephemeral terminations out of service or restored into service utilizing a single service change command. A group of termination IDs is sent within a single Service Change Command. The group of ephemeral termination IDs can be in the form of a list, ranges, or a combination of a list and a range of termination IDs. By including a plurality of ephemeral termination IDs in a single service change command, the number of messages required between the Media Gateway Controller (MGC) and the Media Gateway (MGW) is decreased. Reducing the number of messages makes more efficient use of system bandwidth.

### CROSS-REFERENCE TO RELATED APPLICATION

This application claims the benefit of Provisional Application Ser. No. 60/472,811, filed May 22, 2003.

### FIELD OF THE INVENTION

The present invention relates generally to communication systems, and more particularly to a method for changing the service state of a termination.

### BACKGROUND OF THE INVENTION

FIG. 1 depicts an ephemeral termination ID structure 100 in accordance with the prior art. Ephemeral termination ID message 100 includes X_Prefix 101 and termination number 103. X_Prefix 101 is preferably an alphanumeric string and termination number 103 is preferably numeric. X_Prefix 101 can be, for example, an Asynchronous Transfer Mode (ATM) prefix, an Internet Protocol (IP) prefix, or a more general Ephemeral Prefix.

Each termination has a Termination Identifier (also referred to as TerminationID) that allows both a Media Gateway Controller (MGC) and a Media Gateway (MGW) to identify a specific Termination.

A TerminationID structure for a physical termination may have a hierarchical structure e.g. Level1/Level.1x, and when this is the case H.248 allows for ‘wildcarding’ ALL terminations in Level 1 by doing Level1/*. For ephemeral terminations, there is no corresponding hierarchical structure as it exists for physical terminations.

In ephemeral terminations, such as Real Transport Protocol (RTP) flows, a hierarchical approach to the structure of TerminationIDs realistically is not possible, since the actual physical bearer route is not identified until after the initial termination is added. Given this constraint, individual service change messages are currently sent per termination, and there is no mechanism utilizing the current structure to group service change messages into a single service change command.

Currently, there is no hierarchy for the termination ID structure of present ephemeral terminations. This is typically the case since when initially adding the termination to a MGW, the remote address is typically not known at the time. It is therefore difficult to impose any hierarchy onto the termination ID structure.

Therefore, if a group of ephemeral terminations need to be taken out of service, there is no mechanism to group this set of ephemeral terminations into a single service change message.

Consequently, utilizing the ITU-T H.248 standard, for example, the MGW sends a Service Change command to notify the MGC that a Termination or group of Terminations is about to be taken out of service or has just been returned to service. Therefore, an individual service change message needs to be sent for each ephemeral termination. This requires additional processing and utilizes excessive bandwidth.

Therefore, a need exists for a method that allows a group of ephemeral terminations to be taken out of service in a more efficient manner.

### BRIEF SUMMARY OF THE INVENTION

The present invention provides a method for taking multiple ephemeral terminations out of service utilizing a single service change command. The present invention accomplished this by sending a list of termination IDs within a single Service Change Command.

The present invention provides a single service change command that includes a list of termination IDs. By including a plurality of ephemeral termination IDs in a single service change command, the present invention reduces the number of messages required between the Media Gateway Controller (MGC) and the Media Gateway (MGW). Reducing the number of messages makes more efficient use of system bandwidth.

### BRIEF DESCRIPTION OF THE SEVERAL VIEWS OF THE DRAWINGS

FIG. 1 depicts an ephemeral termination ID structure in accordance with the prior art.

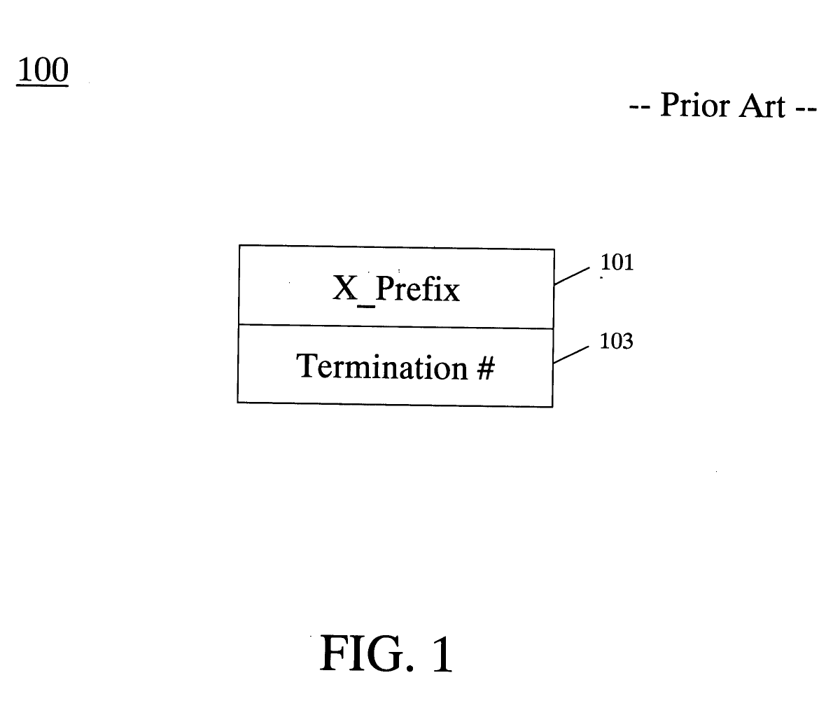

FIG. 2 depicts a service change parameter in accordance with an exemplary embodiment of the present invention.

FIG. 3 depicts the extension field of a service change message in accordance with an exemplary embodiment of the present invention.

FIG. 4 depicts an exemplary service change message in accordance with the ITU-T H.248 standard in accordance with an exemplary embodiment of the present invention.

FIG. 5 depicts a flow chart of a method for sending multiple ephemeral terminations IDs to be taken out of service in a service change message.

FIG. 6 depicts a flow chart of a method for receiving multiple ephemeral terminations IDs to be taken out of service in a service change message.

### DETAILED DESCRIPTION OF THE INVENTION

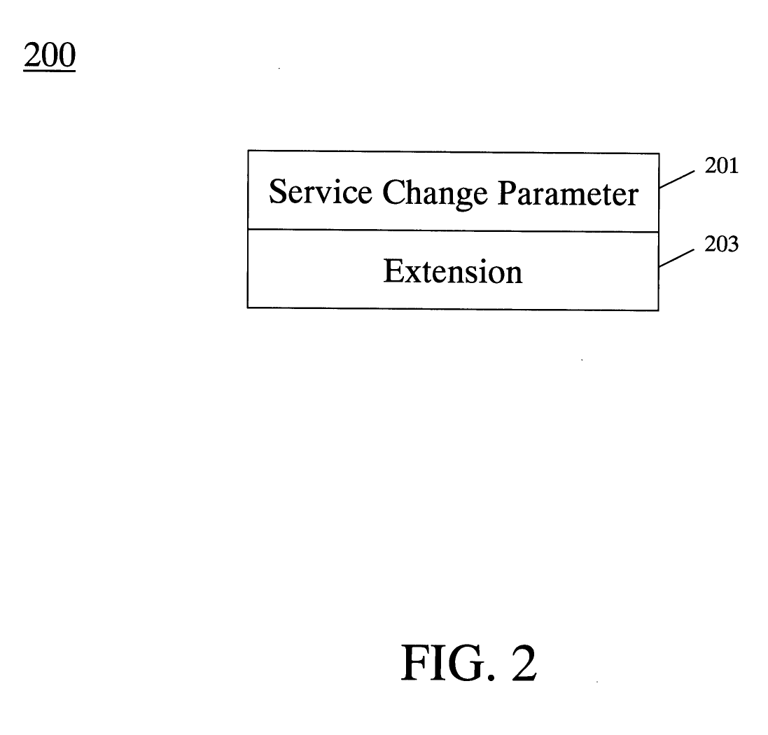

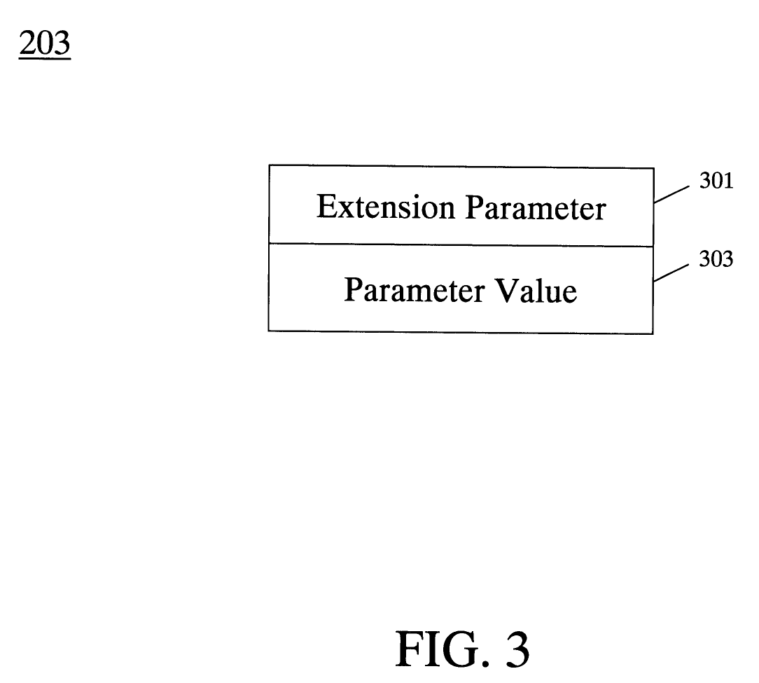

The present invention can be better understood with reference to FIGS. 2 through 6. FIG. 2 depicts a service change parameter 200 in accordance with an exemplary embodiment of the present invention. In an exemplary embodiment, service change parameter 200 is an ITU-T H.248 message. In an exemplary embodiment, service change parameter 200 includes service change parameter field 201 and extension field 203. Service change parameter can be set to a method, reason, delay, address, profile, version, timestamp, or mgcid. In order to group a number of Termination IDs into a single service change command, the present invention makes use of extension field 203, as depicted in FIG. 3.

Service change parameter 200 is a command as part of an ITU-T H.248 message that indicates the service change requested. In the preferred embodiment, service change parameter 200 can include serviceChangeMethod, serviceChangeReason, serviceChangeDelay, serviceChangeAddress, serviceChangeProfile, extension, TimeStamp, serviceChangeMgcId, and/or serviceChangeVersion.

FIG. 3 depicts extension field 203 of service change parameter 200 in accordance with an exemplary embodiment of the present invention. Extension field 203 comprises extension parameter field 301 and parameter value field 303.

Extension parameter field 301 includes an identifier ID for the specific paramValue of the extension. In an exemplary embodiment of the present invention, extension parameter field 301 includes the value of “X-TermID”.

Parameter value field 303 preferably includes the value of the ephemeral terminations to be taken out of service (in the form of a list of Termination IDs and/or ranges of termination IDs). As an example of an exemplary embodiment of the present invention, parameter value field 303 can include a list of termination IDs to be taken out of service, a range of termination IDs to be taken out of service, or a combination of a list and range of termination IDs. A first exemplary embodiment of a list of termination IDs would be {RTP/1, RTP/3, RTP/4}, which indicates that termination IDs 1, 3, and 4 should be taken out of service. A second exemplary embodiment of a range of termination IDs to be taken out of service would be {RTP/1:RTP/6}, which indicates that the range of termination IDs 1 through 6 should be taken out of service. A third exemplary embodiment of the present invention, including a combination of a list and a range of termination IDs, would be {RTP/1, RTP/4:RTP/7, RTP/30}, in which embodiment termination IDs 1, 4, 5, 6, 7, and 30 would be taken out of service.

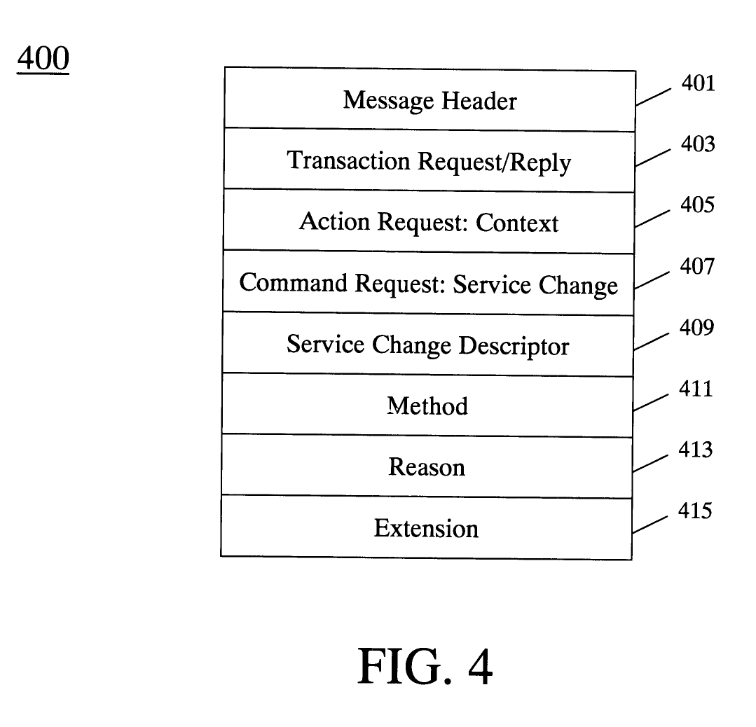

FIG. 4 depicts an exemplary service change message 400 in accordance with the ITU-T H.248 standard in accordance with an exemplary embodiment of the present invention. Service change message 400 preferably comprises a message header field 401, a transaction request/reply field 403, an action request with a context ID field 405, a command request indicating a service change field 407, a service change descriptor 409. Service change descriptor 409 preferably comprises a method field 411, a reason field 413, and an extension field 415.

In an exemplary embodiment of the present invention, service change message 400 is configured in accordance with the ITU-T H.248 standard. In an exemplary embodiment of the present invention, message header field 401 comprises MEGACO/1 [x.x.x.x]:yyyy. Transaction request/reply field 403 is set to value of “1”. Action request with a context ID field 405 is set to “-”. The termination ID is set to a unique value to indicate that the extension field of the message includes the list of termination IDs this H.248 message refers to. Method field 411 is set to “forced”. Reason field 413 is set to “905”.

Extension field 415 is preferably set to the ephemeral terminations that are to be taken out of service. Extension field 415 preferably comprises an extension parameter field and a parameter field, as depicted in FIG. 3. In an exemplary embodiment of the present invention, extension field 415 is set to X−TermID={RTP/6, RTP/10}. In this embodiment, ephemeral termination ID numbers 6 and 10 will be taken out of service, from this single service change message. In a further exemplary embodiment, a range of ephemeral termination IDs can be included within extension field 415 in the parameter value field. For example, extension field 415 could be set to X−TermID={RTP/1:RTP/6}, in which case ephemeral termination messages with termination IDs between 1 and 6 would be taken out of service. In a further exemplary embodiment, a combination of a list and range of termination IDs can be included in a single service change message. In this exemplary embodiment, extension field 415 could be set to, for example, X−TermID={RTP/1, RTP/4:RTP/7, RTP/30}, in which case termination IDs 1, 4, 5, 6, 7, and 30 would be taken out of service from a single service change message.

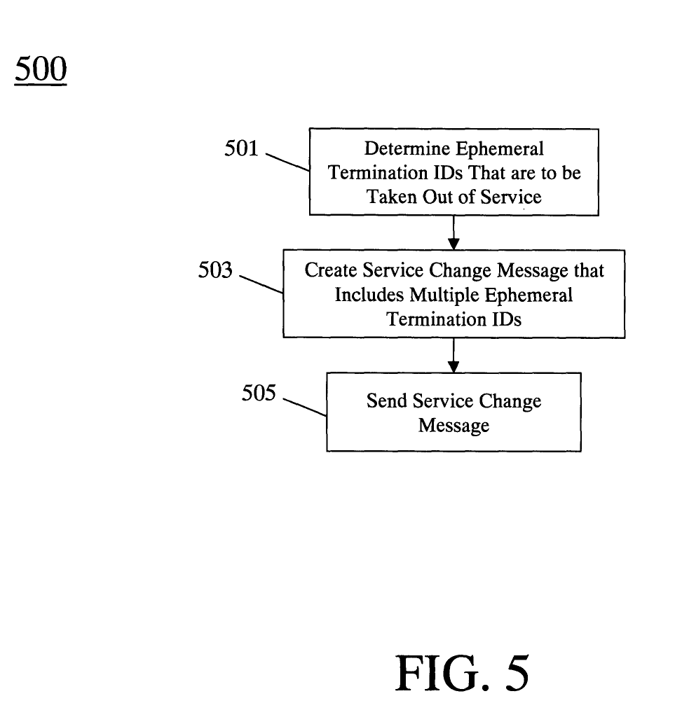

FIG. 5 depicts a flow chart 500 of a method for sending multiple ephemeral terminations IDs to be taken out of service in a service change message. It should be understood that the present invention can also be used to send multiple ephemeral termination IDs to be restored into service in a service change message.

The Media Gateway (MGW) determines (501) a group of ephemeral termination IDs that are to be taken out of service. For example this determination can be made based upon a DSP (Digital Signal Processor) failure that affects more than one termination, an ATM (Asynchronous Transfer Mode) Switched Virtual Circuit (SVC) failure, or an RTP/RTCP (Realtime Transport Protocol) timeout failure. The MGW can be, for example, a Cisco Media Gateway.

The Media Gateway (MGW) creates (503) a service change message that includes reference to multiple ephemeral termination IDs. The service change message would be a message in accordance with FIGS. 2 through 4.

The Media Gateway (MGW) sends (505) the service change message that includes an indication of a plurality of ephemeral termination IDs that are to be taken out of service. The service change message is preferably sent via the H.248 interface.

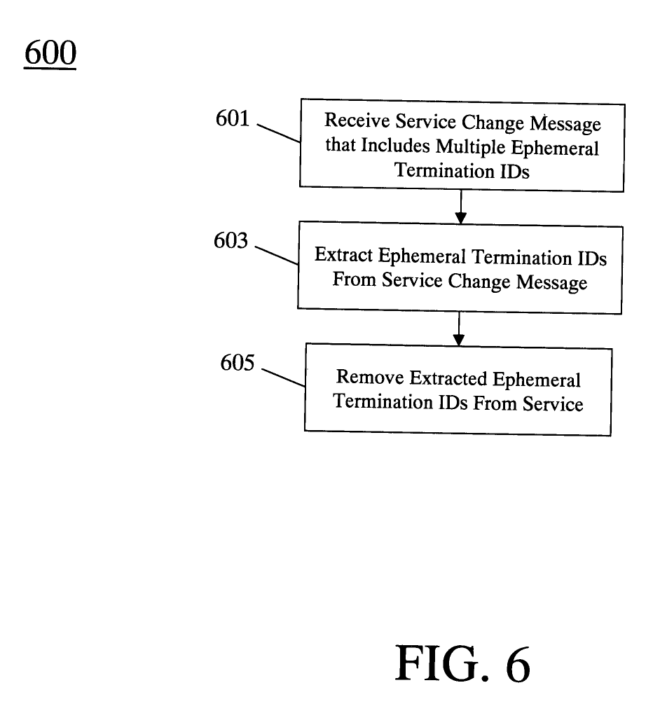

FIG. 6 depicts a flow chart of a method 600 for receiving multiple ephemeral terminations IDs to be taken out of service in a service change message. It should be understood that the present invention can also be used to receive multiple ephemeral termination IDs to be restored into service in a service change message.

The Media Gateway Controller (MGC) receives (601) the service change message that includes an indication of a plurality of ephemeral termination IDs that are to be taken out of service. The service change message is preferably received by the MGC and passes through an H.248 parser. Alternately, the service change message passes through a number of different software layers, with each layer performing the appropriate action. For the LSS (Lucent SoftSwitch), the service change message is parsed and processed by the H.248 Device Server and then some “state of termination” information is passed to the Call Server. The MGC can be, for example, a Lucent SoftSwitch.

The Media Gateway Controller (MGC) extracts (603) the multiple ephemeral termination IDs that are to be taken out of service from the service change message. This is preferably accomplished by looking at the extension field of the Service Change Parameter, where the list and/or range of termination IDs was placed in the ParamValue field.

The Media Gateway Controller (MGC) removes (605) the group of ephemeral termination IDs from service. The removal is dependent upon the type of error that is causing the group of ephemeral terminations to be taken out of service. For example, there can be a GUI (Graphical User Interface) indication, a channel status change, or an H.248 messages triggered towards the MGW to perform some audits, etc.

The present invention thereby provides a method that allows a group of ephemeral terminations to be taken out of service or restored into service in a more efficient manner. This is accomplished by sending a list of termination IDs within a single Service Change Command.

While this invention has been described in terms of certain examples thereof, it is not intended that it be limited to the above description, but rather only to the extent set forth in the claims that follow.

1. A single-handed adjustment mechanism for adjusting a length of a gun strap comprising:
a body comprising first and second horizontal portions spaced by a first aperture and a third horizontal portion spaced from the second horizontal portion by a second aperture;
a bar extending across the first aperture; and
wherein the adjustment mechanism is operable to define a loop of adjustable length in a received length of strap, the length of strap threaded across a selected side of the first horizontal portion of the body, across a selected side of the bar opposing the selected side of the first horizontal portion and across a selected side of the second horizontal portion of the body opposing the selected side of the bar, a second loop formed at a distal portion of the length of strap attaching to the third portion of the body through the second aperture.

2. The single-handed adjustment mechanism of claim 1 wherein the body comprises a single-piece of durable material selected from the group consisting of plastics and metals.

3. The single-handed adjustment mechanism of claim 1 wherein the bar is substantially cylindrical.

4. The single-handed adjustment mechanism of claim 1 wherein the body includes at least one indented lateral portion adapted for manual gripping.

5. A gun sling comprising:
a strap of a selected length having a first end including a first coupling mechanism for coupling to a first point on a gun and a second end including an adjustable loop and a second coupling mechanism slidably retained by the adjustable loop for coupling to a second point on the gun; and
a length adjustment mechanism for single-handedly adjusting a size of the loop and including a body having an aperture therethrough and bar traversing the aperture, a length of the strap threaded under a first horizontal portion of the body, over the bar, and under a following second portion of the body, the length adjustment mechanism slidable along a longitudinal axis of the strap.

6. The gun sling of claim 5 wherein a distal portion of the strap is coupled to the second portion of the body of the adjustment mechanism to close the loop.

7. The gun sling of claim 6 wherein the distal portion of the strap includes a second loop received through a second aperture of the body to couple the distal portion of the strap to the second portion of the body.

8. The gun sling of claim 5 wherein the strap comprises a strap of synthetic webbing material.

9. The gun sling of claim 5 further comprising a shoulder pad coupled to a selected length of the strap.

10. The gun sling of claim 5 wherein the first and second coupling mechanisms comprise first and second swivel mechanisms suitable for engaging first and second swivel studs fastened to the gun.

11. The gun sling of claim 5 wherein the body of the adjustment mechanism is formed as a substantially single piece.

12. The gun sling of claim 5 wherein the single piece is formed from a material selected from the group consisting of plastics and metals.

13. The gun sling of claim 5 wherein the first end of the strap is coupled to the first coupling mechanism with a second loop.

14. The gun sling of claim 13 wherein the second loop is defined by a screw extending through a folded over regions of the strap at the first end.

15. The gun sling of claim 9 wherein the shoulder pad is flexibly coupled to the strap by a plurality of strips of material extending laterally across the shoulder pad and over corresponding portions of the strap.

16. A gun and gun sling assembly comprising:
a gun having first and second swivel studs at first and second gun sling attachment points and a gun sling of a selected length having first and second swivel mechanisms at first and second ends coupled to the first and second swivel studs; and
a gun sling comprising:
a strap of a selected length including a first end coupled to the first attachment point and a second end coupled to the second attachment point, a strap including a loop of adjustable size for adjusting a size of a space defined between the gun and the gun sling; and
a length adjustment mechanism for single-handedly adjusting the size of the loop including a body having an aperture therethrough and bar traversing the aperture, a length of the strap threaded across a first horizontal portion of the body, across an opposing portion of the bar, and across an opposing portion of second horizontal portion of the body, the length adjustment mechanism slidable along a longitudinal axis of the strap.

17. The gun and gun sling assembly of claim 16 wherein the gun is selected from the group consisting of rifles and shotguns.

18. Canceled.

19. The gun and gun sling assembly of claim 16 wherein the gun sling further comprises a shoulder pad.

20. The gun and gun sling assembly of claim 16 wherein the loop is formed from a selected portion of the strap proximate a selected one of the first and second ends of the strap.
